(19) United States
(12) Patent Application Publication
(10) Pub. No.: US 2017/0286987 A1
(43) Pub. Date: Oct. 5, 2017

(54) Methods And Systems For Determining Rewards For Consumers

(71) Applicant: Total Systems Services, Inc., Columbus, GA (US)

(72) Inventors: Phillip Scott Carter, Cumming, GA (US); Raghuram Ram Bongula, Alpharetta, GA (US); Tejashree Bapat, Alpharetta, GA (US); Sandhya Rani Gaddam, Alpharetta, GA (US); Abboud Merheb, Cumming, GA (US)

(21) Appl. No.: 15/490,717

(22) Filed: Apr. 18, 2017

Related U.S. Application Data
(60) Provisional application No. 62/317,676, filed on Apr. 4, 2016.

(51) Int. Cl. G06Q 30/02

(52) U.S. Cl. CPC G06Q 30/0229; G06Q 30/0233; G06Q 30/0215

(57) ABSTRACT

Methods and systems are disclosed for real-time calculation of rewards associated with a commercial transaction. A real-time calculation of rewards can be associated with card payment transactions occurring on a payment account. In an aspect, a customer swiping their bank card at a merchant point of sale to initiate an authorization for a purchase can trigger notification and deliver of rewards associated with the pending commercial transaction.

### CROSS REFERENCE TO RELATED PATENT APPLICATION

This application claims priority to Provisional U.S. Patent Application Ser. No. 62/317,676, filed Apr. 4, 2016, which is herein incorporated by reference in its entirety.

### SUMMARY

It is to be understood that both the following general description and the following detailed description are exemplary and explanatory only and are not restrictive, as claimed. Provided are methods and systems for determination, notification, and redemption of rewards associated with a commercial transaction. In an aspect, one or more of the determination, notification, or redemption can be performed in real-time. An example method can comprise transmitting, from a computing device, to a rewards provider, a notification of a pending commercial transaction at a merchant, receiving, at the computing device, from the rewards provider, a real-time determination of a reward associated with the merchant comprising provisional rewards to be earned based on the pending commercial transaction, transmitting, from the computing device, to the rewards provider, a selected reward, and receiving, at the computing device, from the rewards provider, a notification to redeem the selected reward and complete the pending commercial transaction.

In another aspect, the disclosed method can comprise receiving, from a computing device, a notification of a pending commercial transaction at a merchant, transmitting, to the computing device, a real-time determination of a reward associated with the merchant comprising provisional rewards to be earned based on the pending commercial transaction, receiving, from the computing device, a selected reward, and transmitting, to the computing device, a notification to redeem the selected reward and complete the pending commercial transaction.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram illustrating an example system;

FIG. 2 is a cycle diagram illustrating an example method;

FIG. 3 is a cycle diagram illustrating an example method;

FIG. 4 is a view of a the mobile device interface;

FIG. 5 is a view of a the mobile device interface;

FIG. 6 is a view of a the mobile device interface;

FIG. 7 is a view of a the mobile device interface;

FIG. 8 is a flowchart illustrating an example method;

FIG. 9 is a flowchart illustrating an example method; and

FIG. 10 is a block diagram illustrating an example computing device in which the present methods and systems can operate.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means an example of and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present disclosure relates to methods and systems for determining real-time rewards for consumers. Provided are methods for real-time calculation and redemption of rewards associated with a current commercial transaction. At the time a commercial transaction occurs, a user can be made aware of payment information associated with the transaction, made aware of reward information associated with the transaction, and complete the transaction according to the associated payment information and reward information. For example, a user (e.g., a customer) can receive a notification (e.g., SMS message, email, automated voice message, pop-up window, application specific API, etc.) on a user device (e.g., a computer, a smartphone, a laptop, a tablet, a set top box, a display device, etc.) notifying of a specific opportunity for the user to use and/or earn rewards associated with a commercial product based on a commercial transaction. The user can engage a commercial transaction using an eligible payment product (e.g., cash, credit card, currency, etc.). For example, use of a credit card during a commercial transaction can initiate an authorization process and a real-time reward earning calculation. The authorization process can be performed by a third party. Concurrent with the commercial transaction (e.g., at or near the same time that the commercial transaction occurs) the user can receive, at the user device, a notification associated with a real-time time calculation of rewards earned for the commercial transaction (e.g., real-time purchase notification of eligible rewards) and information associated with the commercial transaction (e.g., notification of a purchase event). In an aspect, the notification can comprise a financial services brand icon, a description, a date/time indicator, and/or a description with an embedded transaction amount. The user can subsequently use eligible rewards to complete (e.g., pay for) the commercial transaction.

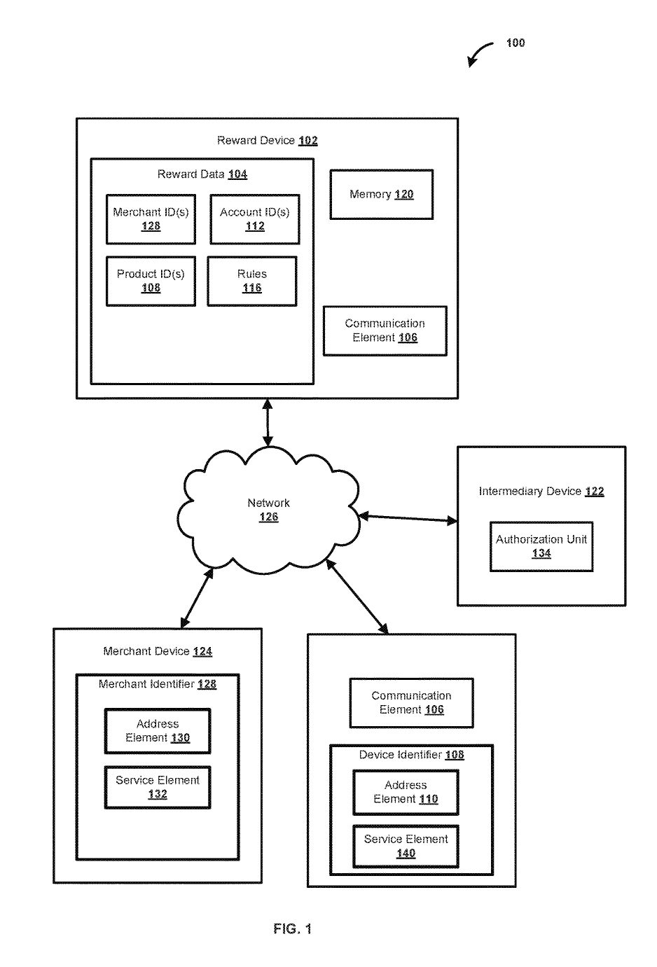

FIG. 1 illustrates various aspects of an exemplar)/environment in which the present methods and systems can operate. The present disclosure is relevant to systems and methods for facilitating a rewards program associated with commercial transactions. For example, a reward device can be configured for real-time calculation of rewards (e.g., points, credits, etc.) associated with a commercial transaction. The rewards associated with the transaction can be redeemed to compensate for a payment amount associated with the commercial transaction. Real-time calculations of rewards can be based on specific rules designated by an issuer of the reward at the time a reward program is defined and/or setup. Those skilled in the art will appreciate that present methods may be used in various types of networks and systems that employ both digital and analog equipment. One skilled in the art will appreciate that provided herein is a functional description and that the respective functions can be performed by software, hardware, or a combination of software and hardware.

The system 100 can comprise a user device 118 in communication with a reward device 102, such as a server, for example. The reward device 102 can be disposed/deployed locally or remotely relative to the user device 118. As an example, the user device 118 and the reward device 102 can be in communication via a network 126. The network 126 can comprise one or more networks, such as a wide area network (e.g., a content network, service network, provider network, the Internet), a public network, an open network, a provider managed network, a non-user managed network, a provider controlled network, a non-user controlled network, a local network, a private network, a closed network, a user managed network, a user controlled network, a user deployed network, and/or the like. Other forms of communications can be used, such as wired and wireless telecommunication channels, for example.

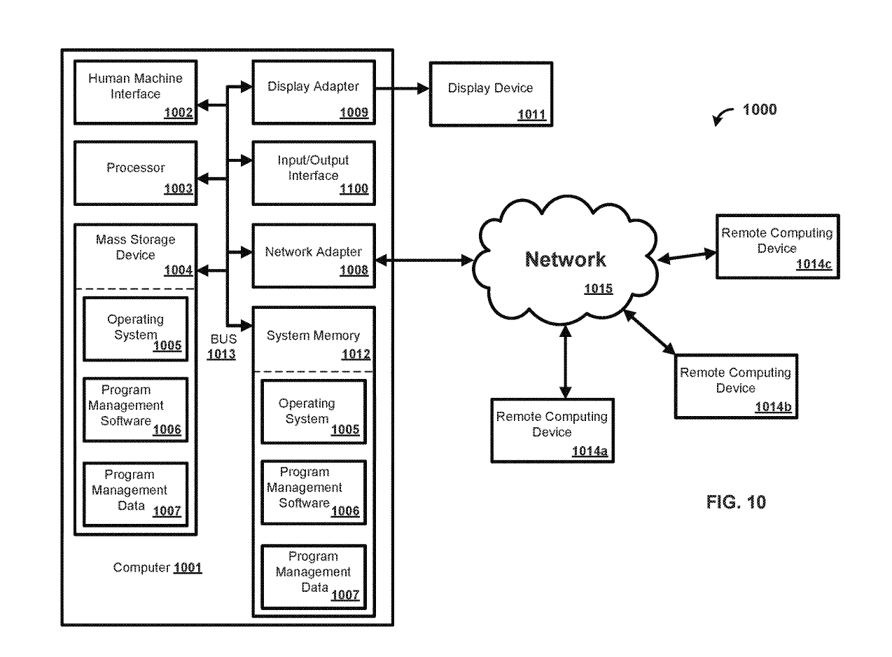

In an aspect, the user device 118 can be a wireless communication device, such as a computer, a smartphone, a laptop, a tablet, a set top box, a display device, or any other device capable of communicating with the reward device 102. The user device 118 can be a computing device (e.g., computer 1001 at FIG. 10). As an example, the user device 118 can comprise a communication element 106 for providing an interface to a user to interact with the user device 118 and/or the reward device 102. The communication element 106 can be any interface for presenting information to the user and receiving a user feedback, such as an application client or a web browser (e.g., Internet Explorer, Mozilla Firefox, Google Chrome, Safari, or the like). Other software, hardware, and/or interfaces can be used to provide communication between the user and one or more of the user device 118 and the reward device 102. As an example, the communication element 106 can request or query various files from a local source and/or a remote source. As a further example, the communication element 106 can transmit data to a local or remote device, such as the reward device 102.

In an aspect, the user device 118 can be associated with a user identifier or device identifier 108. As an example, the device identifier 108 can be any identifier, token, character, string, or the like, for differentiating one user and/or user device (e.g., user device 118) from another user or user device. In a further aspect, the device identifier 108 can identify a user or user device as belonging to a particular class of users or user devices. As a further example, the device identifier 108 can comprise information relating to the user device, such as a manufacturer, a model or type of device, a service provider associated with the user device 118, a state of the user device 118, a locator, and/or a label or classifier. Other information can be represented by the device identifier 108.

In an aspect, the device identifier 108 can comprise an address element 110 and/or a service element 140. In an aspect, the address element 110 can be an hamlet protocol address, a MAC address, a network address, an Internet address, or the like. As an example, the address element 110 can be relied upon to establish a communication session between the user device 118 and the reward device 102 or other devices and/or networks. As a further example, the address element 110 can be used as an identifier or locator of the user device 118. In an aspect, the address element 110 can be persistent for a particular network and/or location.

The system 100 can comprise a merchant device 124. For example, the merchant device 124 can comprise a computing device, such as a point of sale terminal managed by a merchant. The merchant device 124 can be configured to process an exchange (e.g., commercial transaction) between the merchant and consumers, such as participants of a consumer loyalty and/or reward program. The merchant device 124 can be configured to receive account identifiers 112, product identifiers 108, and/or the like to process an exchange (e.g., with or without a user device 118). The merchant device 124 can request the intermediary device 122 to authorize, process, complete, and/or the like, the exchange.

In an aspect, merchant device 124 can be in communication with a reward device 102. The merchant device 124 can be disposed locally or remotely relative to the reward device 102. In an aspect, the reward device 102 and the intermediary device 122 can be the same device. As an example, the merchant device 124 and the reward device 102 can be in communication via the network 126. In an aspect, the merchant device 124 can comprise a wireless communication device, such as a point of sale terminal (POS), a gas pump terminal, a mobile credit card processing device, or any other device capable of communicating with the reward device 102. The merchant device 124 can be a user device. As an example, the merchant device 124 can comprise a communication element 106 for providing an interface to a user to interact with the merchant device 124 and/or the reward device 102. The communication element 106 can be any interface for presenting information to the user and receiving a user feedback, such as an application client or a web browser (e.g., Internet Explorer, Mozilla Firefox, Google Chrome, Safari, or the like). Other software, hardware, and/or interfaces can be used to provide communication between the user and one or more of the merchant device 124 and the reward device 102. As an example, the communication element 106 can request or query various files from a local source and/or a remote source. The communication element 106 can transmit data to a local or remote device, such as the reward device 102.

In an aspect, the merchant device 124 can be associated with a merchant identifier 128. As an example, the merchant identifier 128 can be any identifier, token, character, string, or the like, for differentiating one merchant and/or merchant device (e.g., merchant device 124) from another merchant or merchant device. In a further aspect, the merchant identifier 128 can identify a merchant or merchant device as belonging to a particular class of merchants (e.g., retail merchants, restaurants, gas stations, etc.) or merchant devices (e.g., point of sale terminal, credit card machine, wireless pay terminals, etc.). The merchant device 124 can comprise a magnetic strip, microchip, transmitter, and/or the like for providing information (e.g., payment information) to the reward device 102. For example, the merchant device 124 can report a current commercial transaction (e.g., current product purchase activity). As a further example, the merchant identifier 128 can comprise information relating to the merchant device, such as a manufacturer, a model or type of device, a service provider associated with the merchant device 124, a state of the merchant device 124, a locator, and/or a label or classifier. Other information can be represented by the merchant identifier 108.

In an aspect, the merchant identifier 128 can comprise an address element 130 and/or a service element 132. In an aspect, the address element 130 can be an internet protocol address, a MAC address, a network address, an Internet address, or the like. As an example, the address element 130 can be relied upon to establish a communication session between the merchant device 124 and the reward device 102 or other devices and/or networks. As a further example, the address element 130 can be used as an identifier or locator of the merchant device 124. In an aspect, the address element 130 can be persistent for a particular network and/or location.

The system 100 can comprise an intermediary device 122. The intermediary device can be a computing device (e.g., computer 1001 at FIG. 10). The intermediary device 122 can comprise a device supporting a payment network. For example, a payment network can comprise system or network used for the transfer of money via the use of cash-substitutes (e.g., credit card, bank card, reward card, etc.). In an aspect, the network 126 can comprise a payment network. The intermediary device 122 can be managed by a third-party intermediary. The intermediary device 122 can be configured to process exchanges (e.g., commercial transactions) between merchants and users (e.g., consumers). The authorization unit 134 can be configured to receive and process requests from remote devices, such as the user device 118 or the merchant device 124. In an aspect, a user (e.g., consumer) can submit a payment (e.g., performs a commercial transaction) using an eligible payment product (e.g., credit card, rewards card, etc.) at a merchant device 124. For example, a credit card can be swiped through a card reading device (e.g., POS, merchant device 124) to provide payment for a commercial transaction. When the credit card is swiped through the card reading device, the card reading device can transmit an authorization request to a third party (e.g., a remote transaction card service provider, intermediary device 122). For example, the intermediary device 122 can operate as a third party processor and be configured to determine whether a current exchange is authorized. An authorization request can comprise a request for payment authorization of the commercial transaction. The request for payment authorization can comprise financial services information, description information, date information, time information, and payment information. The authorization unit 134 can be configured to receive and process the authorization requests. For example, the request can comprise a merchant identifier, a product identifier, an account identifier, and/or the like. Authorization unit 134 can associate the payment product (e.g., credit card, bank card, reward card, etc.) to an authorized user account based on the merchant identifier, the product identifier, the account identifier, and/or the like. Authorization request can be received by the intermediary device 122 and processed in real time.

The system 100 can comprise a reward device 102. In an aspect, the reward device 102 can be in communication with a network, such as a network 126. The reward device 102 can comprise rewards data 104 for calculation of one or more rewards. The reward data 104 can comprise information related to a reward. For example, the reward data 104 can comprise one or more (e.g., a collection of) merchant identifiers 128. In an aspect, reward device 102 facilitates the selection of rewards associated with a user and a merchant. Reward information (e.g., merchant provided rewards, provisional rewards, etc.) can be associated with a user account and stored in memory 120. Reward information can be communicated via communication element 106 between a merchant device 124 and the reward device 102 over network 126. For example, a merchant associated with merchant device 124 (e.g., point-of-sale-terminal, payment register, online device, etc.) can communicate rewards information (e.g., rewards for different types of purchases) that is associated with a product of product identifier 108. Reward information can be communicated via communication element 106 from the reward device 102 to a user device 118 over network 126. For example, a user can receive a notification (e.g., real-time purchase notification, SMS message, email, application specific API, etc.) from the reward device 102 regarding a reward and/or promotion at a merchant in close proximity to a user device 118. For example, the communication element 106 can send a notification to the user device 118 (e.g., consumer's mobile phone, personal computer, car or wearable device). The notification can inform the user (e.g., consumer) of a potential reward, a successful purchase, a purchase amount, a provisional reward earning amount associated with a commercial transaction, and/or combinations thereof. In an aspect, the user device 118 can be a wireless communication device, such as a computer, a smartphone, a laptop, a tablet, a set top box, a display device, or other device capable of communicating with the reward device 102.

Reward device 102 can receive and store information (e.g., user preferences indicating a preference for certain types of rewards or other preference) associated with the user device 118. Reward device 102 can provide (e.g., notify, send notification, etc.) information to the user device 118, notifying the user of the user device 118 of one or more merchants offering rewards associated with a particular commercial transaction. For example, a user can be notified at the user device 118 of points and/or credits to be earned based on a prospective commercial transaction. As another example, a user can be notified at the user device 118 of points and/or credits already earned based previous commercial transactions.

User device 118 can communicate commercial transaction information, location information, and other information associated with the user to reward device 102. For example, user device 118 can communicate information associated with a current commercial transaction to, such as payment information, to reward device 102 through network 126, enabling reward device 102 to associate user device 118 to a user account based on an account identifier 112. Reward device 102 can determine whether the user device 118 is associated with a user account by relating the device identifier 108 to the account identifier 112. The association between the user device 118 and the account identifier 112 can enable reward device 102 to automatically determine rewards associated with the user device 118. For example, a user device may be used to communicate location information or other information associated with a commercial transaction at one or more merchant devices. The information can enable the reward device 102 to determine a reward available to the user based on reward data associated with the current commercial transaction.

In an aspect, the reward device 102 can comprise rewards data 104 for determining one or more rewards. The reward data 104 can comprise information related to a reward. For example, the reward data 104 can comprise one or more (e.g., a collection of) merchant identifiers 128. A merchant can comprise any entity offering a product and/or service for purchase. The collection of merchant identifiers 128 can comprise identifiers for business chains, individual locations of a chain, categories of merchants (e.g., health, food, office supplier, fuel, etc.), terminals (e.g., transaction terminal of a specific merchant, identifying a sub-merchant) and/or the like that collectively form a merchant network. The merchant identifier 124 can identify merchants that are associated with pre-established rewards, reward programs, deals and/or combinations thereof. The merchant identifier 124 can identify merchants that are associated with the merchant network.

The reward data 104 can comprise one or more product identifiers 108. The product identifiers 108 can identify specific products, types of products, categories of products, brand name of products, and/or the like. For example, the product identifiers 108 can identify commercial products available to users via a merchant associated with a reward.

In an aspect, the reward data 104 can comprise one or more account identifiers 112. The account identifiers 112 can identify accounts of the users, merchants, and/or combinations thereof.

in an aspect, the reward data 104 can comprise one or more rules 116. The rules 116 can be defined, specified, and/or the like by the merchant. The rules 116 can comprise conditions, such as reward qualification conditions. For example, the reward qualification conditions can comprise conditions for receiving an asset, such as a reward. The qualification conditions can be configured to incentivize behavior such as eating habits, active lifestyle, spending habits, study habits, purchasing from specific vendors, traveling to specific locations (e.g., merchant stores), watching advertisements, participating in events (e.g., political event, community service), arid/or the like. For example, the rules 116 can associate qualification conditions with rewards. The rules 116 can specify specific rewards that are associated with satisfaction of corresponding qualification conditions. The rules 116 can specify events (e.g., reward event, funding of asset, placement of asset, granting of a permission) triggered by the conditions. An example rule 116 can specify that an asset, such as a reward, is transferred to or otherwise associated with an account.

In an aspect, the rules 116 can comprise redemption conditions (e.g., purchase condition, account conditions). For example, a purchase condition can specify a merchant, product category, product identifier and/or the need to redeem an asset (e.g., current, reward, voucher, coupon). The redemption conditions can be specified (e.g., defined, selected) by the merchant, a rewards provider, a third party, and or combinations thereof. Redemption conditions can comprise conditions for redeeming or otherwise using a reward, transferred to and/or associated with a user device. Redemption conditions can specify conditions for using rewards to complete a commercial transaction (e.g., a current commercial transaction, previous commercial transaction, etc.). For example, the redemption conditions can specify that a reward can only be used for a product or service associated with a specific product identifier (e.g., unique product, category of products, brand of products). As another example, the redemption conditions can specify that a reward can be used as payment for a product either prior to, during, or after a commercial transaction.

The redemption conditions can specify that a reward can only be redeemed at a merchant associated with a specific merchant identifier e.g., unique merchant, merchant chain, grocery store, health care provider).

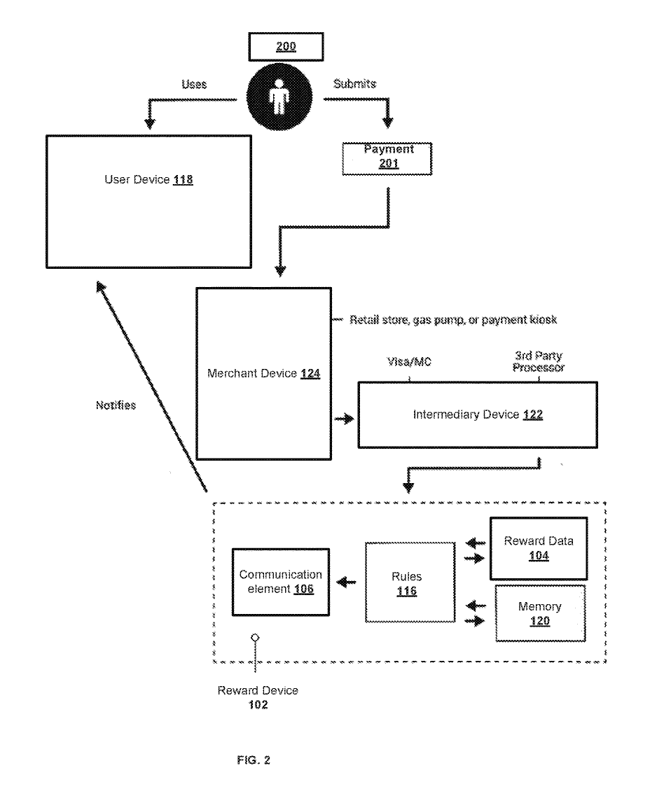

FIG. 2 illustrates a life cycle of the method for determining real-time rewards for consumers. FIG. 2 illustrates that, in an aspect, a consumer 200 can submit a payment 201 (e.g., performs a commercial transaction) using an eligible payment product (e.g., credit card, rewards card, etc.) at a merchant device 124 (e.g., retail point of sale, online, telephonically, etc.). The payment 201 can be routed through a merchant payment processor associated with the merchant device 124 to the intermediary device 122 (e.g., a third party processor) for approval and/or authorization. After the intermediary device 122 processes (e.g., authorizes, approves, etc.) the payment 201, purchase details associated with the commercial transaction are routed to the reward device 102. The reward device 102 can calculate a reward (e.g., provisional reward, earned reward, etc.). The reward device 102 can determine reward earning eligibility based on the reward data 104 and the rules 116. In an aspect, reward data and rules associated can be associated with the medium used (e.g., bank card, credit card, rewards card, etc.) by the consumer 200 during the commercial transaction. Reward earnings can be determined and provided (e.g. rewarded) to the user via the user device 118 on a provisional basis. For example, notifying the consumer 200 of a potential reward earning amount that can be rewarded once the merchant (e.g., merchant device 124) resolves the commercial transaction (e.g., a purchase of a product). After the reward earnings (e.g., provisional reward earn amount, earned award amount, etc.) is determined, the reward device 102 can send a notification (e.g., SMS message, email, application specific API, real-time purchase notification, etc.) to the user device 118 (e.g., a consumer mobile phone, a personal computer, a car, a wearable device, etc.) via communication element 106. The purchase notification can inform the consumer 200 of a successful purchase, a purchase amount, a provisional earning amount, combinations thereof, and the like.

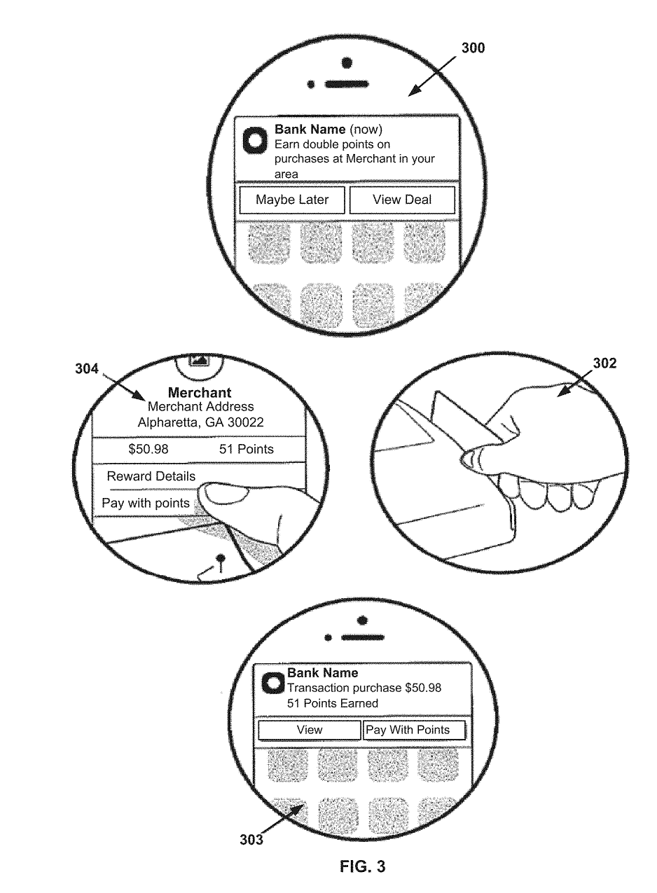

FIG. 3 illustrates a life cycle of the method for determining real-time rewards for consumers. FIG. 3 illustrates a real-time rewards determination life cycle. In an aspect, a customer can undergo four states of engagement associated with a commercial transaction. A customer can receive a notification informing them of a rewards promotion at a nearby merchant at 300. In an aspect, the notification can be associated with a tag, a sound, a vibration, an email, a SMS message, near-field communication, application specific API, combinations thereof, and the like. The notification can be received on a user device such as a computing device, a smartphone, a laptop, a tablet, a set top box, a display device, etc.

At 301, the customer attempts a purchase at the merchant using a payment card, mobile device or other eligible payment product. Authorization details are received by the reward provider (e.g., merchant, third party, etc.) and are processed in real-time to calculate provisional earnings for the commercial transaction (e.g., purchase transaction). In an aspect, the provisional rewards amount awarded can be based on rewards program rules.

At 302, the customer can receive a provisional reward earn notification (e.g., notification from reward device 102) thanking the customer for using their bank card for the purchase, and informing them of the provisional rewards earned based on the commercial transaction. In an aspect, the notification can comprise access to a “Pay with Rewards” feature at 303. The “Pay with Rewards” feature can enable the customer to redeem the provisional rewards. For example, the consumer can use eligible rewards to credit the full amount of the commercial transaction.

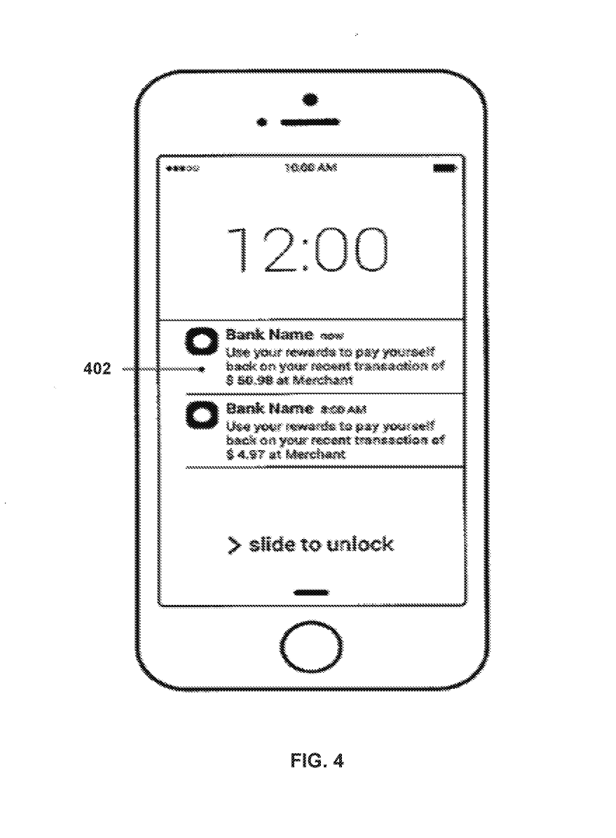

FIG. 4 is a front view of a mobile device in the locked mode after receiving a real-time purchase notification (402). The real-time purchase notification can comprise a financial services brand icon, a description, a date/time indicator, and/or a description with an embedded transaction amount. In an aspect, the mobile device can be a user device 118 and the notification can be transmitted from the reward device 102. In an aspect, the notification can be associated with a tag, a sound, a vibration, an email, a text message, combinations thereof, and the like.

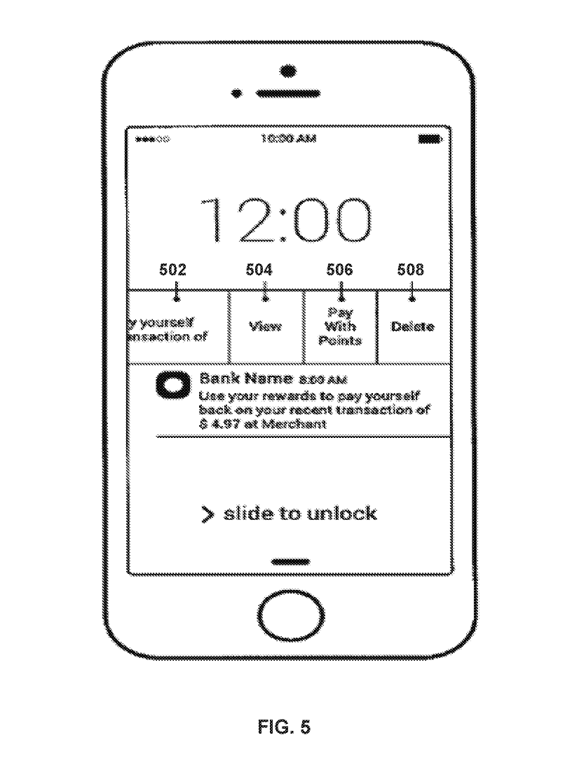

FIG. 5 is a front view of a mobile device comprising a real-time purchase notification. In an aspect, the mobile device can be a user device 118. In an aspect, a user can perform “swipe actions” associated with the real-time purchase notification. For example, swiping to the left reveals convenience features such as pay yourself 502, view 504, pay with reward points 506, or message deletion 508. In an aspect, a user can perform a variety of actions associated with the real-time purchase notification. For example, the user can reveals convenience features such as pay yourself 502, view 504, pay with reward points 506, or message deletion 508 by pressing buttons, interacting with an interface, motion associated with the mobile device (e.g., tilt, shake, orientation, etc.)

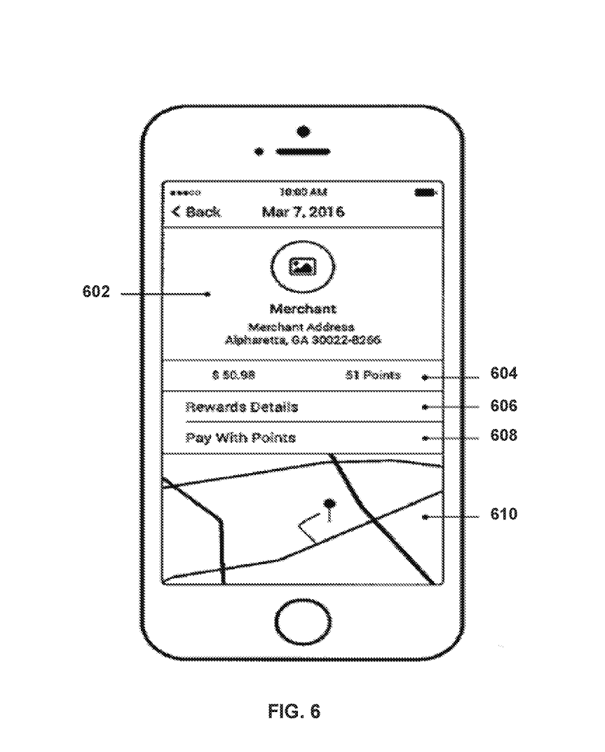

FIG. 6 is a front view of a mobile device comprising a software application associated with a real-time purchase notification. In an aspect, the mobile device can be a user device 118. In an aspect, the application can present a number of convenience features comprising merchant information 602, a transaction amount 604, rewards detail 606, an option to pay with rewards 608, and/or combinations thereof. In a further aspect, the application can be configured to reflect a location of a current payment transaction location in a map view 610.

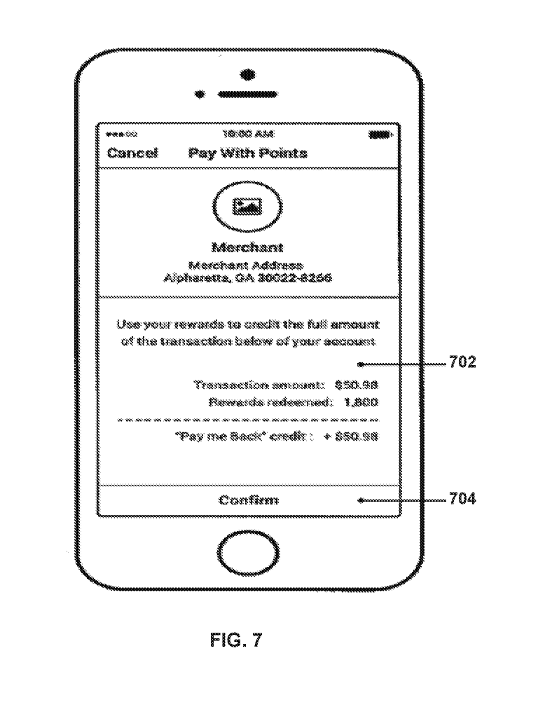

FIG. 7 is a front view of a mobile device comprising a software application associated with a real-time purchase notification after a user selects pay with rewards 608. FIG. 7 illustrates a review screen from which a user can view and finalize rewards redemption 702 and confirm 704 that they would like to pay themselves back for a full transaction amount.

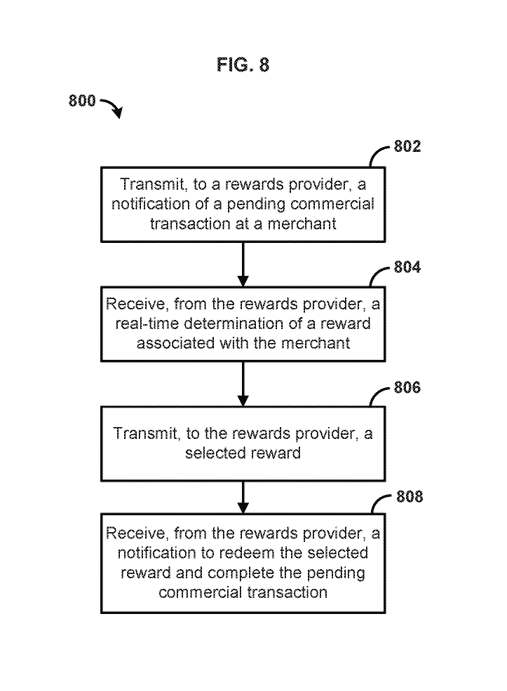

FIG. 8 is a flowchart illustrating an example method 800. In step 802 a computing device (e.g., user device 118) can transmit, to a rewards provider reward device 102, a provider of commercial based digital rewards and content for marketing promotions, a provider of consumer loyalty rewards, etc.) a notification of a pending commercial transaction at a merchant location (e.g., merchant device 124, retail store, business, gas pump, payment kiosk, etc.). In an aspect, the notification can comprise information associated with a user (e.g., a consumer), the commercial transaction, combinations thereof, and the like. As an example, the notification can comprise consumer information, financial services information, description information, date information, time information, and payment information associated with the commercial transaction. Additionally, the notification can comprise location information, product information, merchant information, payment type information, combinations thereof, and the like.

In an aspect, the notification can be in response to usage of a card (e.g., credit card, bank card, rewards card, etc.) to engage in a commercial transaction. In an aspect, the notification can be in response to a user accessing (e.g., login) a user account to engage in cash-based commercial transaction. For example, a user at a merchant location (e.g., merchant device 124, retail store, gas pump, payment kiosk, etc.), prior to making a cash-based commercial transaction, can login to a user account and provide details associated with the commercial transaction. The details associated with the transaction can include user profile information, merchant information, product information, price information, combinations thereof, and the like. Based on the details associated with the commercial transaction, a notification of the pending commercial transaction can be sent to the rewards provider.

In step 804, the computing device can receive, from the rewards provider, a real-time determination of a reward(s) associated with the merchant comprising provisional rewards to be earned based on the pending commercial transaction. In an aspect, the provisional rewards can be advantages associated with the commercial transaction such as loyalty benefits, perks, promotions, incentives, combinations thereof, and the like offered by a merchant to customers for patronizing the merchant. The real-time determination of the reward can be based on information associated with the user and/or merchant, such as purchase history, consumer product affiliation, credit card information, payment information, consumer account information, combinations thereof, and the like. For example, a user making a credit card purchase at a merchant location (e.g., merchant device 124, retail store, gas pump, payment kiosk, etc.) can receive, on their smartphone, based on an association with the user's credit card information, a real-time calculation of points or credits that can be redeemed at the point-of-sale to pay for and/or complete the commercial transaction. In an aspect, a user making a cash purchase at a merchant location can received, on their smartphone, based on an association to a user account, a real-time calculation of points or credits that can be redeemed at the point-of-sale to pay for and/or complete the commercial transaction. For example, prior to making a cash purchase at a merchant location, a user can login to a user account and receive a real-time calculation of points and/or credits that can be redeemed based on the pending cash purchase.

In an aspect, a user can determine when they receive the real-time determination of the reward(s). For example, the real-time determination of reward(s) may not be sent to the computing device if it is determined that the provisional rewards would not fully covered a balance associated with the pending commercial transaction. As an example, the user with a pending commercial transaction involving a cost/payment of $100 may not receive a real-time determination of a reward valued at $60 because $60 would not cover the commercial transaction. Alternatively, even though the provisional reward of $60 would not cover the balance of the pending commercial transaction, the user may still be notified of the provisional reward. In an aspect, the user may specify a percentage of a pending commercial transaction that must be covered by the real-time determination of the reward(s) in order to receive the real-time determination of the reward(s). For example, the user may only receive the real-time determination of the reward(s) if at least 50% of the pending commercial transaction balance can be covered by the reward(s).

In an aspect, the user can select, via the computing device, based on the real-time determination of the reward(s), a reward (e.g., one or more rewards) the user would like to redeem.

In step 806, the computing device can transmit, to the rewards provider, the selected reward(s). In an aspect, the selected reward(s) can comprise a provisional reward (e.g., rewards, points, and/or credits to be earned based on the current transaction) and/or an earned reward (e.g. rewards, points, and/or credits earned based on previous commercial transactions).

In step 808, the computing device can receive, from the rewards provider, a notification to redeem the selected reward(s) and complete the pending commercial transaction. In an aspect, the selected reward(s) can be associated with an exchangeable value. The exchangeable value can be expressed in terms of a modification (e.g., increase or decrease) in an amount/cost associated with a consumer product. The selected reward(s) can be redeemed/exchanged for a decrease in (or resolution of) a purchase price of an item. For example, a consumer product can have a purchase price of $50.98, and the selected reward(s) can be an accumulated value of 51 points. The accumulated value can be applied to and/or used to offset the purchase price of the consumer product such that the user is not be required to provide money (e.g., $50.98) to cover the purchase price of the consumer product. As such, the user can use the selected reward, the accumulated value of 51 points, to purchase a product with a purchase price of $50.98. In another aspect, the selected reward(s) can be used as a determent of payment, and/or a forbearance of payment.

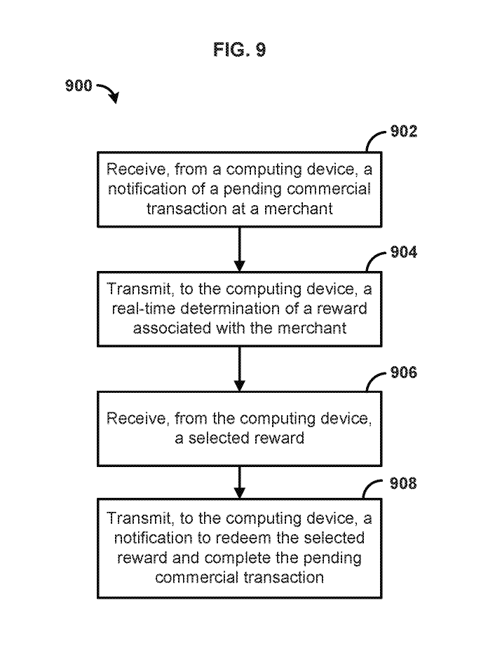

FIG. 9 is a flowchart illustrating an example method 900. In step 902, a rewards provider (e.g., reward device 102, a provider of commercial based digital rewards and content for marketing promotions, a provider of consumer loyally rewards, etc.) can receive, from a computing device (e.g., user device 118), a notification of a pending commercial transaction at a merchant location (e.g., merchant device 124, retail store, business, gas pump, payment kiosk, etc.). In an aspect, the notification can comprise information associated with a user (e.g., a consumer) and/or commercial transaction. As an example, the notification can comprise consumer information, financial services information, description information, date information, time information, and payment information associated with the commercial transaction. Additionally, the notification can comprise location information, product information, merchant information, payment type information, combinations thereof, and the like. In an aspect the notification can be in response to usage of a card (e.g., credit card, bank card, rewards card, etc.) to engage in the commercial transaction. In an aspect the notification can be in response to a user accessing (e.g., login) to a user account to engage in cash-based commercial transaction. For example, a user at a merchant location (e.g., merchant device 124, retail store, gas pump, payment kiosk, etc.), prior to a cash-based commercial transaction, can login to a user account and provide details associated with the commercial transaction. The details associated with the transaction can include user profile information, merchant information, product information, price information, combinations thereof, and the like. Based on the details associated with the commercial transaction, a notification of the pending commercial transaction can be sent to the rewards provider.

In step 904, the rewards provider can transmit, to the computing device, a real-time determination of a reward(s) associated with the merchant comprising provisional rewards to be earned based on the pending commercial transaction. In an aspect, the provisional rewards can be advantages associated with the commercial transaction such as a loyalty benefits, perks, promotions, incentives, combinations thereof, and the like, offered by a merchant to customers for patronizing the merchant. The real-time determination of the reward can be based on information associated with the user and/or merchant, such as purchase history, consumer product affiliation, credit card information, consumer account information, payment information, combinations thereof, and the like. For example, a user making a credit card purchase at a merchant location (e.g., merchant device 124, retail store, gas pump, payment kiosk, etc.) can received, on their smartphone, based on an association with the user's credit card information, a real-time calculation of points and/or credits that can be redeemed at the point-of-sale to pay for and/or complete the commercial transaction. In an aspect, a user making a cash purchase at a merchant location can received, on their smartphone, based on an association to a user account, a real-time calculation of points and/or credits that can be redeemed at the point-of-sale to pay for and/or complete the commercial transaction. For example, prior to making a cash purchase at a store, a user can login to a user account and receive a real-time calculation of points and/or credits that can be redeemed based on the pending cash purchase.

In an aspect, a user can determine when they receive the real-time determination of the reward(s). For example, a real-time determination of reward(s) may not be sent to the computing device if it is determined that the provisional rewards would not fully covered a balance associated with the pending commercial transaction. As an example, a user with a pending commercial transaction involving a cost/payment of $100 may not receive a real-time determination of a reward valued at $60 because $60 would not cover the pending commercial transaction. Alternatively, even though the provisional reward of $60 would not cover the balance of the pending commercial transaction, the user may still desire to be notified of the provisional reward. In an aspect, the user may specify a percentage of a pending commercial transaction that must be covered by the real-time determination of the reward(s) in order to receive the real-time determination of the reward(s). For example, the user may only receive the real-time determination of the reward(s) if at least 50% of the pending commercial transaction balance can be covered by the reward(s).

In an aspect, a user can select, via the computing device, based on the real-time determination of the reward(s), a reward (e.g., one or more rewards) the user would like to redeem.

In step 906, the rewards provider can receive, from the computing device, the selected reward(s). In an aspect, the selected reward(s) can comprise a provisional reward (e.g., rewards, points, and/or credits to be earned based on the current transaction) and/or an earned reward (e.g. rewards, points, and/or credits earned based on previous commercial transactions).

In step 908, the rewards provider can transmit, to the computing device, a notification to redeem the selected reward(s) and complete the pending commercial transaction. In an aspect, the selected reward(s) can be associated with an exchangeable value. The exchangeable value can be expressed in terms of a modification (e.g., increase or decrease) in an amount; cost associated with a consumer product. The selected reward(s) can be redeemed/exchanged for a decrease in (or resolution of) a purchase price of an item. For example, a consumer product can have a purchase price of $50.98, and the selected reward(s) can be an accumulated value of 51 points. The accumulated value can be applied to and/or used to offset the purchase price of the consumer product such that the user may not be required to provide money (e.g., $50.98) to cover the purchase price of the consumer product. As such, the user can use the selected reward, an accumulated value of 51 points, to purchase a product with a purchase price of $50.98. In another aspect, the selected reward(s) can be used as a deferment of payment, and/or a forbearance of payment.

In an exemplary aspect, the methods and systems can be implemented on a computer 1001 as illustrated in FIG. 10 and described below. By way of example, reward device 102, intermediary device 122, user device 118, and the merchant device 124 of FIG. 1 can be computers as illustrated in FIG. 10. Similarly, the methods and systems disclosed can utilize one or more computers to perform one or more functions in one or more locations. FIG. 10 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 1001. The components of the computer 1001 can comprise, but are not limited to, one or more processors 1003, a system memory 1012, and a system bus 1013 that couples various system components including the one or more processors 1003 to the system memory 1012. The system can utilize parallel computing.

The system bus 1013 represents one or more of several possible types of bus structures, including a memory bus or memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1013, and all buses specified in this description can also be implemented over a wired or wireless network connection and each of the subsystems, including the one or more processors 1003, a mass storage device 1004, an operating system 1005, program management software 1004, program management data 1004, a network adapter 1008, the system memory 1012, an Input/Output Interface 1010, a display adapter 1009, a display device 1011, and a human machine interface 1002, can be contained within one or more remote computing devices 1014a,b,c at physically separate locations, connected through buses of this form, in effect implementing a fully distributed system.

The computer 1001 typically comprises a variety of computer readable media. Exemplary readable media can be any available media that is accessible by the computer 1001 and comprises, for example and not meant to be limiting, both volatile and non-volatile media, removable and non-removable media. The system memory 1012 comprises computer readable media in the form of volatile memory, such as random access memory (RAM), and/or non-volatile memory, such as read only memory (ROM). The system memory 1012 typically contains data such as the program management data 1004 and/or program modules such as the operating system 1005 and the program management software 1004 that are immediately accessible to and/or are presently operated on by the one or more processors 1003.

In another aspect, the computer 1001 can also comprise other removable/non-removable, volatile/non-volatile computer storage media. By way of example, FIG. 15 illustrates the mass storage device 1004 which can provide non-volatile storage of computer code, computer readable instructions, data structures, program modules, and other data for the computer 1001. For example and not meant to be limiting, the mass storage device 1004 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 1004, including by way of example, the operating system 1005 and the program management software 1004. Each of the operating system 1005 and the program management software 1004 (or some combination thereof) can comprise elements of the programming and the program management software 1004. The program management data 1004 can also be stored on the mass storage device 1004. The program management data 1004 can be stored in any of one or more databases known in the art. Examples of such databases comprise, DB2®, Microsoft® Access, Microsoft® SQL Server, Oracle®, mvSQL, PostgreSQL, and the like. The databases can be centralized or distributed across multiple systems,

In another aspect, the user can enter commands and information into the computer 1001 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the one or more processors 1003 via the human machine interface 1002 that is coupled to the system bus 1013, but can be connected by other interface and bus structures, such as a parallel port, game port, an IEEE 1394 Port (also known as a Firewire port), a serial port, or a universal serial bus (USB).

In yet another aspect, the display device 1011 can also be connected to the system bus 1013 via an interface, such as the display adapter 1009. It is contemplated that the computer 1001 can have more than one display adapter 1009 and the computer 1001 can have more than one display device 1011. For example, the display device 1011 can be a monitor, an LCD (Liquid Crystal Display), or a projector. In addition to the display device 1011, other output peripheral devices can comprise components such as speakers (not shown) and a printer (not shown) which can be connected to the computer 1001 via the Input/Output Interface 1010. Any step and/or result of the methods can be output in any form to an output device. Such output can be any form of visual representation, including, but not limited to, textual, graphical, animation, audio, tactile, and the like. The display device 1011 and computer 1001 can be part of one device, or separate devices.

The computer 1001 can operate in a networked environment using logical connections to one or more remote computing devices 1014a,b,c. By way of example, a remote computing device can be a personal computer, portable computer, smartphone, a server, a router, a network computer, a peer device or other common network node, and so on. Logical connections between the computer 1001 and a remote computing device 1014a,b,c can be made via a network 1015, such as a local area network (LAN) and/or a general wide area network (WAN). Such network connections can be through the network adapter 1008. The network adapter 1008 can be implemented in both wired and wireless environments. Such networking environments are conventional and commonplace in dwellings, offices, enterprise-wide computer networks, intranets, and the Internet.

For purposes of illustration, application programs and other executable program components such as the operating system 1005 are illustrated herein as discrete blocks, although it is recognized that such programs and components reside at various times in different storage components of the computing device 1001, and are executed by the one or more processors 1003 of the computer. An implementation of the program management software 1004 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM. EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial intelligence techniques such as machine learning and iterative learning. Examples of such techniques include, but are not limited to, expert systems, case based reasoning, Bayesian networks, behavior based AI, neural networks, fuzzy systems, evolutionary computation (e.g., genetic algorithms), swarm intelligence (e.g., ant algorithms), and hybrid intelligent systems (e.g., Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
transmitting, from a computing device, to a rewards provider, a notification of a pending commercial transaction at a merchant;
receiving, at the computing device, from the rewards provider, a real-time determination of a reward associated with the merchant comprising provisional rewards to be earned based on the pending commercial transaction;
transmitting, from the computing device, to the rewards provider, a selected reward; and
receiving, at the computing device, from the rewards provider, a notification to redeem the selected reward and complete the pending commercial transaction.

2. The method of claim 1, wherein the notification of the pending commercial transaction comprises financial services information, description information, date information, time information, and payment information.

3. The method of claim 1, wherein the notification of the pending commercial transaction is in response to a usage of a card associated with currency.

4. The method of claim 1, wherein the notification of the pending commercial transaction is in response to a user accessing a user account.

5. The method of claim 1, wherein the transmitting, from the computing device, to the rewards provider, the notification of the pending commercial transaction, is in response to receiving a notification of rewards offered by the merchant, wherein the merchant is within a proximity of the computing device.

6. The method of claim 1, wherein the determination of rewards associated with the merchant further comprises earned rewards.

7. A method comprising:
receiving, from a computing device, a notification of a pending commercial transaction at a merchant;
transmitting, to the computing device, a real-time determination of a reward associated with the merchant comprising provisional rewards to be earned based on the pending commercial transaction;
receiving, from the computing device, a selected reward; and
transmitting, to the computing device, a notification to redeem the selected reward and complete the pending commercial transaction.

8. The method of claim 7, wherein the notification of the pending commercial transaction comprises financial services information, description information, date information, time information, and payment information.

9. The method of claim 7, wherein the notification of the pending commercial transaction is in response to a usage of a card associated with currency.

10. The method of claim 7, wherein the notification of the pending commercial transaction is in response to a user accessing a user account.

11. The method of claim 7, wherein the receiving the notification of the pending commercial transaction is in response to transmitting a notification of rewards offered by the merchant, wherein the merchant is within a proximity of the computing device.

12. The method of claim 7, wherein the determination of rewards associated with the merchant further comprises earned rewards.

13. The method of claim 7, wherein transmitting the determination of the reward is based on one or more user preferences.

14. A system comprising:
a first device configured to:
transmit, to a second device, a notification of a pending commercial transaction at a merchant;
receiving, from the second device, a real-time determination of a reward associated with the merchant comprising provisional rewards to be earned based on the pending commercial transaction;
transmit, to the second device, a selected reward; and
receive, from the second device, a notification to redeem the selected reward and complete the pending commercial transaction.

15. The system of claim 14, wherein the notification of the pending commercial transaction comprises financial services information, description information, date information, time information, and payment information.

16. The system of claim 14, wherein the first device is further configured to transmit the notification of the pending commercial transaction in response to a usage of a card associated with currency.

17. The system of claim 14, wherein the first device is further configured to transmit the notification of the pending commercial transaction in response to a user accessing a user account.

18. The system of claim 14, wherein the notification of the pending commercial transaction, is in response to receiving the notification of rewards offered by the merchant, wherein the merchant is within a proximity of the first device.

19. The system of claim 14, wherein the determination of rewards associated with the merchant further comprises earned rewards.

20. The system of claim 14, wherein the first device is further configured to transmit the determination of the reward based on one or more user preferences.
